(19) United States
(12) Patent Application Publication
(10) Pub. No.: US 2024/0164378 A1
(43) Pub. Date: May 23, 2024

(54) SYNERGISTIC PLANT GROWTH STIMULANT COMPOSITIONS OF POTASSIUM MONO/DI-FORMATE WITH CARBOXYLIC ACIDS

(71) Applicant: FERTIS INDIA PVT. LTD., Hyderabad (IN)

(72) Inventors: Rahul Raju KANUMURU, Hyderabad (IN); George Kochumalayil SHAJI, Hyderabad (IN); Lakshmi Prasanna Kumar GARUDADRI, Hyderabad (IN); Ravikumar SURANENI, Hyderabad (IN); Sil ANINDYA, Hyderabad (IN)

(21) Appl. No.: 18/551,823

(22) PCT Filed: Mar. 25, 2022
(86) PCT No.: PCT/IN2022/050298

§ 371 Date: Sep. 21, 2023

(30) Foreign Application Priority Data
Mar. 26, 2021 (IN) 202141013476

(51) Int. Cl. A01N 37/42; A01N 37/44; A01N 59/24; A01P 21/00; C05F 11/10

(52) U.S. Cl. CPC A01N 37/42; A01N 37/44; A01N 59/24; A01P 21/00; C05F 11/10

(57) ABSTRACT

The present invention discloses synergistic plant growth stimulating composition of organic potassium salts comprising potassium mono/diformate or potassium hydrogen di-salt of organic acids in combination with aliphatic or aromatic carboxylic acids or its salts optionally with plant growth hormones/growth regulators. The composition of the present invention improves plant growth, enhances the yield and quality produce of the plants/crops.

### FIELD OF INVENTION

The present invention relates to synergistic plant growth stimulating composition of organic potassium salts comprising potassium mono/diformate or potassium hydrogen di-salt of organic acids in combination with aliphatic or aromatic carboxylic acids or its salts optionally with plant growth hormones/growth regulators. The composition of the present invention improves plant growth, enhances the yield and quality produce of the crops.

### BACKGROUND AND PRIOR ART

The plant growth and development as well as productivity of the crops, fruits, flowers etc. are known to be regulated by mineral components, growth hormones and small molecules that signal for expression of genes which enhance the level of plant productivity. The traditional methods of improving the plant growth include supplementing the soil or the plant with nitrogen, phosphorous, potassium (NPK) nutrients and other micro nutrients.

The present traditional methods are insufficient in the wake of growing pollution, environmental changes, rapid depletion of soil quality due to excessive use of fertilizers and other abiotic stresses such as increase level of salts in the soil, drought, cold, heat and heavy metal stresses, waterlogging stress and biotic stress on plants by living organisms specially viruses, bacteria, fungi, nematodes, insects, arachnids and weeds. These agents directly deprive their host of its nutrients can lead to death of plants. Biotic stress can become major problem because of pre- and postharvest losses.

Potassium is normally required by a growing plant to stimulate early growth, to increase protein production, and to activate beneficial enzyme and hormone systems within the plant which impact the plant's ability to withstand biotic and abiotic stress.

The typical potassium sources used are the inorganic potassium salts such as potassium chloride, potassium magnesiumsulfate, potassiumnitrate and potassium sulfate. The use of inorganic potassium salts, however, is found to have damaging effect on the environment.

Fertilizers are now provided with potassium derived from environmentally friendly organic potassium source.

WO2017/040938 provides fertilizer comprising soluble nitrogen, a phosphate source and a potassiumsource, wherein, the potassium source is an organic potassium source, animal manure, carboxylic acid salts of potassium, potassium silicate and combinations thereof. The nitrogen source is selected from the group consisting of urea, nitrate, triazone urea, ammonia, ammonium salts, ammonium hydroxide, amino acids, fish meal or extract, compost extract, kelp extract, shrimp extract, shellfish extract, and combinations thereof. The carboxylic acid salt of potassium is selected from potassium formate and/or monocarboxylic or dicarboxylic acids such as potassiumacetate, potassium propionate, potassium butyrate, potassium valerate, potassium hexanoate, potassium oxalate, potassiummalonate, potassium succinate, potassium glutarate, potassium adipate, potassium lactate, potassium malate, potassium citrate, potassium glycolate, potassium tartrate, potassiumglyoxylate, potassium pyruvate, and combinations thereof.

Plant hormones such as auxins, cytokinins, gibberellins, ethylene and abscisic acid greatly improve plant vigor, promote growth of roots and shoots and reduce stress.

EP1408761B1 discloses the use of oxytocin in combination with an adjuvant and/or carrier in the composition in order to stimulate plant growth.

U.S. Pat. No. 2,382,326A discloses a plant growth stimulant composition in dry powdered form capable of inducing rooting and stimulating healthy vigorous plant growth comprising allantoin, a plant hormone along with plant nutrient materials and plant micrometabolic elements.

EP3071534A1 discloses fertilizer compositions comprising granules of plant hormones, for example gibberellic acid-coated granules, methods of preparing such compositions, and application of such compositions to soil.

The present inventors felt that there is a scope in the art to provide an improved and effective plant growth stimulant composition capable of stimulating vigorous plant growth thereby improving the quality and yield of the crops.

### SUMMARY OF THE INVENTION

In accordance with the objective, the present invention provides synergistic plant growth stimulating composition comprising organic potassium salts selected from potassium mono/diformate or potassium hydrogen di-salt of organic acids as the potassium source in combination with aliphatic or aromatic carboxylic acids or its salts and adjuvants optionally with plant growth hormones/plant growth regulators.

In an aspect, the ratio of potassium mono or di-formate or potassium hydrogen di-salt of organic acids to the aliphatic or aromatic carboxylic acids or its salts in the composition ranges from 4:1 to 2:1.

The potassium hydrogen di-salt of organic acids includes but is not limited to potassium hydrogen diacetate.

The aliphatic carboxylic acids are selected from formic acid, acetic acid, propionic acid, butyric acid, pelarganoic acid, caprilic acid, capric acid, stearic acid, lauric acid, palmitic acid, adipic acid, fumaric acid, lactic acid, malic Acid, phenyl lactic acid, succinic acid, tartaric acid, citric acid, ascorbic acid or their salts alone or combination thereof. The aromatic carboxylic acids are selected from substituted or unsubstituted benzoic acid or their salts, phenyl acetic acid, phenols, salicylic acid, gallic acid or their salts, phenolic precursors (including but not limited to phenylalanine and/or capsaicin and/or valine etc.), rosmarinic acid, caffeic acid, cinnamic acid, coumaric acid, ferulic acid or their salts and the like alone or combination thereof.

In another aspect, the composition of the present invention may comprise the plant growth hormones/plant growth regulator selected from the group consisting of auxin, cytokinin, gibberellic acid, melatonin, brassinosteroids, ethylene, abscisic acid, salicylic acid and jasmonic acid and the like alone or combination thereof in the range of 0.05% to 10% w/w.

The plant growth stimulating composition of the present invention may further comprise adjuvants/excipients and or surfactants selected from anionic and Non-ionic and Cationic surfactants such as CMC, Lignosulfonates and the like alone or combination thereof in an amount ranging from 2% to 4% w/w to ensure uniform and wide spreading of the composition on the plant when applied to give complete application of foliage by maintaining surface tension of leaf and molecule contact to the plant.

In another aspect, the present invention provides a process for preparation of said plant growth stimulant composition comprising organic potassium salts selected from potassium mono/diformate or potassium hydrogen di-salt of organic acids as the potassium source in combination with aliphatic or aromatic carboxylic acid and adjuvants optionally in combination with plant growth hormones/plant growth regulators.

In yet another aspect, the present invention provides a method to stimulate the growth in plants comprising applying an effective plant growth stimulating composition to the areas where plants are growing.

### DESCRIPTION OF THE FIGURES

FIG. 1: Depicts the comparative total phenol concentration in ppm in paddy grains

FIG. 2: Depicts the total protein content in paddy grains

### DETAILED DESCRIPTION OF THE INVENTION

The present invention will now be will now be explained in detail with reference to its various preferred as well as optional embodiment, which, however should not be construed to limit the scope of the invention.

In an embodiment, the present invention relates to a synergistic plant growth stimulating composition comprising;
(i) Organic potassium salts selected from potassium mono/diformate or potassium hydrogen di-salt of organic acids as the potassium source;
(ii) Aliphatic or aromatic carboxylic acids or their salts thereof;
(iii) Optionally with plant growth hormones/plant growth regulators in an amount ranging from 0.05% to 10% w/w; and
(iv) Adjuvants/excipients in an amount ranging from 2% to 4% w/w;

wherein the ratio of potassium mono/diformate or potassium hydrogen di-salt of organic acids to the aliphatic or aromatic carboxylic acids or its salts in said composition ranges from 4:1 to 2:1.

The potassium hydrogen di-salt of organic acids includes but is not limited to potassium hydrogen diacetate.

The aliphatic carboxylic acids are selected from formic acid, acetic acid, propionic acid, butyric acid, pelarganoic acid, caprilic acid, capric acid, stearic acid, lauric acid, palmitic acid, adipic acid, fumaric acid, lactic acid, malic acid, phenyl lactic acid, succinic acid, tartaric acid, citric acid, ascorbic acid or their salts alone or combination thereof.

The aromatic carboxylic acids are selected from substituted or unsubstituted benzoic acid or their salts, phenyl acetic acid, phenols, salicylic acid, gallic acid or their salts, phenolic precursors (including but not limited to phenylalanine and/or capsaicin and/or valine etc.), rosmarinic acid, caffeic acid, cinnamic acid, coumaric acid, ferulic acid or their salts and the like alone or combination thereof.

The plant growth hormones/plant growth regulator in the present composition are selected from the group consisting of auxin, cytokinin, gibberellic acid, melatonin, brassinosteroids, ethylene, abscisic acid, salicylic acid and jasmonic acid and the like alone or combination thereof in the range of 0.05% to 10% w/w.

Phenolics are aromatic benzene ring compounds with one or more hydroxyl groups produced by plants mainly for protection against stress. The functions of phenolic compounds in plant physiology and interactions with biotic and abiotic environments are difficult to overestimate. Phenolics play important roles in plant development, particularly in lignin and pigment biosynthesis. They also provide structural integrity and scaffolding support to plants. Importantly, phenolic phytoalexins, secreted by wounded or otherwise perturbed plants, repel or kill many microorganisms.

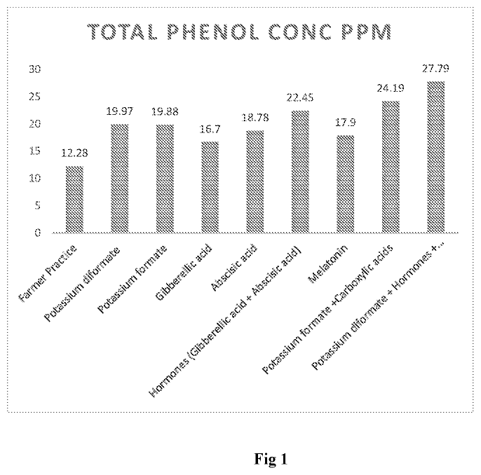

In an aspect, the present composition comprising combination of Potassium diformate and carboxylic acids and the composition of Potassium diformate, Hormones and Carboxylic acids exhibit synergistic effect in terms of increased phenol concentration in paddy grains as depicted in FIG. 1.

The present composition delivers 0.5 to 50% of potassium depending on its source in the final composition.

In an embodiment, the present composition comprising of potassium mono/diformate in combination with carboxylic acids optionally with hormones may contain agriculturally acceptable excipients along with farmer practice like with all kinds of N, P, K fertilizers and supplements in appropriate proportion.

The plant growth stimulating composition of the present invention may further comprise adjuvants and or surfactants selected from anionic and Non-ionic and Cationic surfactants such as CMC, Lignosulfonates, and the like alone or combination thereof in an amount ranging from 2% to 4% w/w to ensure uniform and wide spreading of the composition on the plant when applied to give complete application of foliage by maintaining surface tension of leaf and molecule contact to the plant.

In an embodiment, the composition contain antioxidant like sodium nitroprusside in the range of 0.5 to 25% of the formulation to enhance the nitrogen use efficiency and antioxidant property with or without combination of agriculturally acceptable excipients, N, P, K fertilizers and supplements.

In yet another embodiment, the present invention relates to the process for preparation of said plant growth stimulating composition thereof.

In an embodiment the plants/crops are selected from the group consisting of cucurbit vegetables, peppers, potatoes, carrots, radishes, grapes, cole crops, paddy grains, leafy vegetables and tomatoes.

The composition of the present invention may be formulated as solid in the form of tablets, powders, granules, pellets or in liquid form or in spray forms using suitable excipients/vehicles. The proportion of the various substances in the composition may vary depending upon its intended use and the particular forms in which they are applied.

In an embodiment, the composition of the present invention is applied/delivered on to the plants/plant parts in an amount of 100 g to 1000 g per acre as foliar or injectable on selective plant parts.

In another embodiment, the composition of the present invention is used for stimulating the growth in plants, to enhance the yield and quality produce of the plants.

In an embodiment, the present invention provides a method to stimulate the growth in plants comprising applying an effective plant growth stimulating composition comprising the organic potassium salts selected from potassium mono/diformate or potassium hydrogen di-salt of organic acids as the potassium source in combination with aliphatic or aromatic carboxylic acids or their salts, optionally in combination with plant growth hormones/plant growth regulators to the areas where plants are growing.

The following examples are illustrative of the composition embodying the present invention for use as plant growth stimulators.

### Example 1

Potassium Mono/Di-Formate with Carboxylic acids

| Sr. | | Gm in Qty/ | Gm in Qty/ | Gm in Qty/ |
|---|---|---|---|---|
| No | Component name | acre | acre | acre |
| 1 | Potassium mono/di | 200 | 100 | 400 |
| | formate | | | |
| 2 | Citric acid | 40 | 20 | 80 |
| 3 | salicylic acid | 13.8 | 6.9 | 27.6 |
| 4 | Ascorbic acid | 40 | 20 | 80 |
| 5 | Adjuvants(Surfactants) | 10 | 5 | 20 |
| 6 | Total weight in gm | 303.8 | 151.9 | 607.6 |

### Example 2

Potassium Mono/Di-Formate with Carboxylic acids and hormones

| Sr | | gm in Qty/ | gm in Qty/ | gm in Qty/ |
|---|---|---|---|---|
| No | Component name | acre | acre | acre |
| 1 | Potassium mono/ | 200 | 100 | 400 |
| | di formate | | | |
| 2 | Citric acid | 40 | 20 | 80 |
| 3 | salicylic acid | 13.8 | 6.9 | 27.6 |
| 4 | Ascorbic acid | 40 | 20 | 80 |
| 5 | Gibberellic acid | 2 | 1 | 4 |
| 6 | Melatonin | 2.25 | 1.125 | 4.5 |
| 7 | Abscisic acid | 1 | 0.5 | 2 |
| 8 | Adjuvants/ | 10 | 5 | 20 |
| | surfactants | | | |
| | Total weight in gm | 309.05 | 154.525 | 618.1 |

### Example 3

Potassium Mono/Di-Formate with Carboxylic
acids and hormones and Antioxidant

| Sr | | g in Qty/ | g in Qty/ | g in Qty/ |
|---|---|---|---|---|
| No | Component name | acre | acre | acre |
| 1 | Potassium mono/ | 200 | 100 | 400 |
| | di formate | | | |
| 2 | Citric acid | 40 | 20 | 80 |
| 3 | salicylic acid | 13.8 | 6.9 | 27.6 |
| 4 | Ascorbic acid | 40 | 20 | 80 |
| 5 | Gibberellic acid | 2 | 1 | 4 |
| 6 | Melatonin | 2.25 | 1.125 | 4.5 |
| 7 | Abscisic acid | 1 | 0.5 | 2 |
| 8 | Sodium | 10 | 5 | 25 |
| | nitroprusside | | | |
| 8 | Adjuvants/ | 10 | 5 | 20 |
| | surfactants | | | |
| | Total weight in gm | 319.05 | 159.525 | 643.1 |

### Example 4: Total Phenol Estimation in Paddy Grains

TABLE 1

| S. NO | Sample name | Conc ppm |
|---|---|---|
| 1 | Farmer Practice Normal NPK basal application | 12.28 |
| 2 | Farmer practice with Potassium diformate | 19.97 |
| 3 | Farmer practice with Potassium formate | 19.88 |
| 4 | Farmer practice with Gibberellic acid | 16.7 |
| 5 | Farmer practice with Abscisic acid | 18.78 |
| 6 | Farmer practice with Hormones (Gibberellic acid + | 22.45 |
| | Abscisic acid) | |
| 7 | Melatonin | 17.9 |
| 8 | Potassium formate + Carboxylic acids (Example 1) | 24.19 |
| 9 | Farmer practice with Potassium diformate + | 27.79 |
| | Hormones + Carboxylic acids(Example 3) | |

Results: The composition comprising Potassium diformate+carboxylic acids (example-1) and the composition of Potassium diformate+Hormones+Carboxylic acids (example-3) show synergistic effect in terms of increased phenol concentration (FIG. 1).

### Example 5: Total Protein Content in Paddy Grains

TABLE 2

| | | % of |
|---|---|---|
| S. NO | Sample name | Protein |
| 1 | Farmer Practice Normal N, P, K, application | 0.006 |
| 2 | Farmer Practice with Potassium diformate | 0.012 |
| 3 | Farmer Practice with Potassium formate | 0.011 |
| 4 | Farmer Practice with Gibberellic acid | 0.008 |
| 5 | Farmer Practice with Abscisic acid | 0.008 |
| 6 | Farmer Practice with Hormones (Gibberellic acid + | 0.011 |
| | Abscisic acid) | |
| 7 | Farmer Practice with potassium mono/diformate with | 0.019 |
| | Hormones | |
| 8 | Potassium formate + Carboxylic acids (Example 1) | 0.02 |
| 9 | Potassium diformate + Hormones + Carboxylic acids | 0.025 |
| | (Example 3) | |

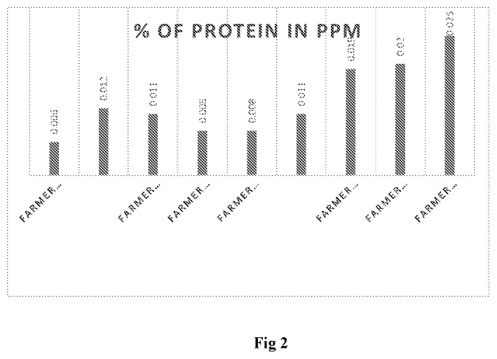

Results: The composition comprising Potassium diformate+carboxylic acids (example-1) and the composition of Potassium diformate+Hormones+Carboxylic acids (example-3) show synergistic effect in terms of increased protein content (FIG. 2).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A synergistic plant growth stimulating composition comprising;
(v) Organic potassium salts selected from potassium monoformate, potassium diformate or potassium hydrogen di-salts of organic acids as a potassium source;
(vi) Aliphatic or aromatic carboxylic acids or salts thereof;
(vii) Optionally with plant growth hormones/plant growth regulators in an amount ranging from 0.05% to 10% w/w; and
(viii) Adjuvants in an amount ranging from 2% to 4% w/w;
wherein the ratio of potassium monoformate, potassium diformate or potassium hydrogen di-salts of organic acids to the aliphatic or aromatic carboxylic acids or salts thereof in said composition ranges from 4:1 to 2:1.

2. The synergistic plant growth stimulating composition as claimed in claim 1, wherein the aliphatic carboxylic acids are selected from formic acid, acetic acid, propionic acid, butyric acid, pelarganoic acid, caprilic acid, capric acid, stearic acid, lauric acid, palmitic acid, adipic acid, fumaric acid, lactic acid, malic acid, phenyl lactic acid, succinic acid, tartaric acid, citric acid, ascorbic acid or their salts alone or in any combination thereof.

3. The synergistic plant growth stimulating composition as claimed in claim 1, wherein the aromatic carboxylic acids are selected from substituted or unsubstituted benzoic acid or their salts, phenyl acetic acid, phenols, salicylic acid, gallic acid or their salts, phenolic precursors, rosmarinic acid, caffeic acid, cinnamic acid, coumaric acid, ferulic acid or their salts alone or in any combination thereof.

4. The synergistic plant growth stimulating composition as claimed in claim 1, wherein the plant growth hormones/plant growth regulator are selected from the group consisting of auxin, cytokinin, gibberellic acid, melatonin, brassinosteroids, ethylene, abscisic acid, salicylic acid and jasmonic acid alone or in any combination thereof.

5. The synergistic plant growth stimulating composition as claimed in claim 1, wherein the composition further comprises agriculturally acceptable excipients, N, P, K fertilizers and supplements.

6. The synergistic plant growth stimulating composition as claimed in claim 1, wherein the composition contains an antioxidant in the range of 0.5 to 25% of the formulation to enhance the nitrogen use efficiency and antioxidant property with or without combination of agriculturally acceptable excipients, N, P, K fertilizers and supplements.

7. The synergistic plant growth stimulating composition as claimed in claim 1, wherein the composition is formulated as a solid or in a liquid form or in a spray form using excipients/vehicles.

8. The synergistic plant growth stimulating composition as claimed in claim 1, for stimulating the growth in plants, to enhance the yield and quality produce of the plants.

9. A method to stimulate the growth in plants comprising applying a plant growth stimulating composition according to claim 1 to the areas where plants are growing.

10. The synergistic plant growth stimulating composition as claimed in claim 2, wherein the phenolic precursors include phenylalanine, capsaicin, valine and any combination thereof.

11. The synergistic plant growth stimulating composition as claimed in claim 6, wherein the antioxidant is sodium nitroprusside.
